(19) United States
(12) Patent Application Publication
(10) Pub. No.: US 2012/0324462 A1
(43) Pub. Date: Dec. 20, 2012

(54) VIRTUAL FLOW PIPELINING PROCESSING ARCHITECTURE

(75) Inventors: Zoran Miljanic, Princeton, NJ (US); Milena Miljanic, Princeton, NJ (US)

(73) Assignee: RUTGERS, THE STATE UNIVERSITY OF NEW JERSEY, New Brunswick, NJ (US)

(21) Appl. No.: 13/505,244

(22) PCT Filed: Oct. 30, 2010
(86) PCT No.: PCT/US10/54897

§ 371 Date: Aug. 20, 2012

Related U.S. Application Data
(60) Provisional application No. 61/256,955, filed on Oct. 31, 2009.

(51) Int. Cl. G06F 9/46

(52) U.S. Cl. 718/103

(57) ABSTRACT

A computer system for embodying a virtual flow pipeline programmable processing architecture for a plurality of wireless protocol applications is disclosed. The computer system includes a plurality of functional units for executing a plurality of tasks, a synchronous task queue and a plurality of asynchronous task queues for linking the plurality of tasks to be executed by the functional units in a priority order, and a virtual flow pipeline controller. The virtual flow pipeline controller includes a processing engine for processing a plurality of commands; a scheduler, communicatively coupled to the processing engine, for selecting a next task for processing at run time for each of the plurality of functional units; a processing engine controller, communicatively coupled to the processing engine, for providing commands and arguments to the processing engine and monitoring command completion; and a task flow manager, communicatively coupled to the processing engine controller, for activating the next task for processing. Also disclosed is a computer-implemented method for executing a plurality of wireless protocol applications embodying a virtual flow pipeline programmable processing architecture in a computer system.

### RELATED APPLICATIONS

This application claims the benefit of U.S. Provisional Application No. 61/256,955 filed Oct. 31, 2009, the specification of which is herein incorporated by reference in its entirety

### FIELD OF THE INVENTION

Embodiments of the invention relate generally to broadband wireless communication protocol applications and, more particularly, to programmable radio processing devices having high throughput processing requirements.

### BACKGROUND INFORMATION

The fast evolution of wireless communication protocols drives the need for the programmable processing support with communication System-on-Chip devices (hereinafter “SoC-s”). In the case of infrastructure devices the flexibility would extend the lifetime and obviate forklift replacements, while in the case of the portable end-user devices the flexibility will not only ensure longer lifetime but will also achieve a wider reach as the user travels between areas covered by different radio access protocol standards.

More recently, the demand for flexibility has driven attempts to design SoC devices using general and special purpose DSP processors. Unfortunately the computational complexity of the current and emerging communication protocols at the physical layer (baseband) is too high for software based implementations. For instance, the processing power required for the GSM (Global System for Mobile communications) cellular telephony standard that was introduced in 1992 is 10 MIPS/channel, while processing requirements for WCDMA (Wideband Code Division Multiple Access) third generation (3G) cellular communication is 3000 MIPS/channel. This corresponds to 104% CAGR (compound aggregate growth rate), compared to 57% CAGR of Moore's law describing the semiconductor performance growth. In addition, while Moore's law holds for general purpose processors, it does not hold for System on Chip devices, predominantly used in communication devices, which experience only CAGR of 22% The slower growth rate for SoC devices is contributed to the fact that the reduction in wire delays, which are dominant in SoC devices centered around a system bus, does not scale linearly with the reduction in the semiconductor gate geometry. The modern wireless LAN OFDM protocols require at least 5000 MIPS processing power. On the other hand, broadband wireless standards, like WiMAX (Worldwide Interoperability of Microwave Access) and LTE (Long Term Evolution) will require even 4 to 10 times more processing power than wireless LAN. Clearly, the design gap between CAGR of more than 100% for processing complexity and CAGR of 22% for processing power will only increase.

Predominantly software implementation will require massively parallel implementations with hundreds of CPU-s. This type of SoC architectures results in complex and high priced semiconductor chips. In addition, they do not scale after reaching the limits chip size physical implementation. The speedup of parallel processing is hard to achieve because of the fine granularity of wireless protocol processing operations resulting in high overhead of parallelization.

Thus, most commercial chips vendors resort to the hardware implementation for the high speed and computationally complex functions. This approach results in a very limited or no flexibility.

There are currently two competing wireless standards for the next generation broadband wireless networks: IEEE 802.16 WiMAX (Worldwide Interoperability for Microwave Access) and 3GPP LTE (Long Term Evolution). Both standards are conceptually very similar, but with the significant differences in implementation details. While WiMAX has the advantage of early start and existing deployments worldwide, LTE has some technical advantages for the mobile applications and it has been largely embraced by the major mobile telephony telecom operators as the standard of choice for the next rollout of infrastructure upgrades, starting in 2010. In reality both standards will coexist in the future, and both will keep evolving for the forcible future, most likely for at least one decade.

### SUMMARY OF THE INVENTION

There would be tremendous advantages for the telecom operators and end users if the wireless devices can be designed in a way to make them programmable in the field for the future upgrades, and even better to reconfigure themselves for the interoperability across the networks.

There is a clear need for innovative architectures that achieve a flexible processing solution at the complexity similar to the hardware based fixed solution, in particular in the proposed domain of emerging wireless communication protocol processing designs. In a quest for such solutions, understanding computational complexity, workload characteristics and flexibility requirements of target applications is a must. The functional requirement analysis will lead towards a choice of functional units required for processing, and, also, their granularity and the degree of flexibility specifications. The workload analysis will specify the control structure required to effectively and efficiently combine the operations of the functional units. Effectiveness of the control scheme will determine the programming difficulty, while efficiency will specify the functional unit utilization and, ultimately, the device complexity.

In an exemplary embodiment, a computer system is provided for embodying a virtual flow pipeline programmable processing architecture for a plurality of wireless protocol applications. The computer system includes a plurality of functional units for executing a plurality of tasks, a synchronous task queue and a plurality of asynchronous task queues for linking the plurality of tasks to be executed by the functional units in a priority order, and a virtual flow pipeline controller. The virtual flow pipeline controller includes a processing engine for processing a plurality of commands; a scheduler, communicatively coupled to the processing engine, for selecting a next task for processing at run time for each of the plurality of functional units; a processing engine controller, communicatively coupled to the processing engine, for providing commands and arguments to the processing engine and monitoring command completion; and a task flow manager, communicatively coupled to the processing engine controller, for activating the next task for processing.

In another embodiment, a computer-implemented method for executing a plurality of wireless protocol applications is disclosed. The method embodies a virtual pipeline flow programmable processing architecture in a computer system. The method comprises: (a) placing a plurality of tasks to be executed by a plurality of functional unites in the computer system into a plurality of task queues including a synchronous task queue and a plurality of asynchronous task queues; (b) liking the plurality of tasks to be executed by the functional units in a priority order; (c) processing a plurality of commands by a processing engine component of a virtual flow pipeline controller; (d) selecting a next task for processing for each of the plurality of functional units at run time by a task flow manager coupled to the processing engine component; (e) providing commands and arguments to the processing engine and monitoring command completion by a processing engine controller; and (f) activating the next task for processing by a task flow manager coupled to the processing engine controller.

### BRIEF DESCRIPTION OF THE DRAWINGS

FIG. 1 is a block diagram of a System-on-a-Chip (SoC) in accordance with one embodiment of the disclosed virtual flow pipeline programmable processing architecture. It represents the SoC with multiple clusters of functional units, with processing of functional units controlled by Virtual Flow Pipelining (VFP) controller.

FIG. 2 represents diagrams of hardware pipeline processing, and Virtual Flow Pipeline based processing.

FIG. 3 is a flow diagram of task messages between functional units, exchanged during virtual flow pipeline based task processing.

FIG. 4 is a block diagram of Virtual Flow Pipeline Controller.

### DETAILED DESCRIPTION

One embodiment is a System-on-a-Chip with the set of functional units performing communication protocol and application processing. The Functional Units (FU-s) can be either hardware based engines with the set of supported functions; each function identified by the name and operands, of a software programmable Central Processing Units (CPU-s), where each function is identified by the program start address and its operands.

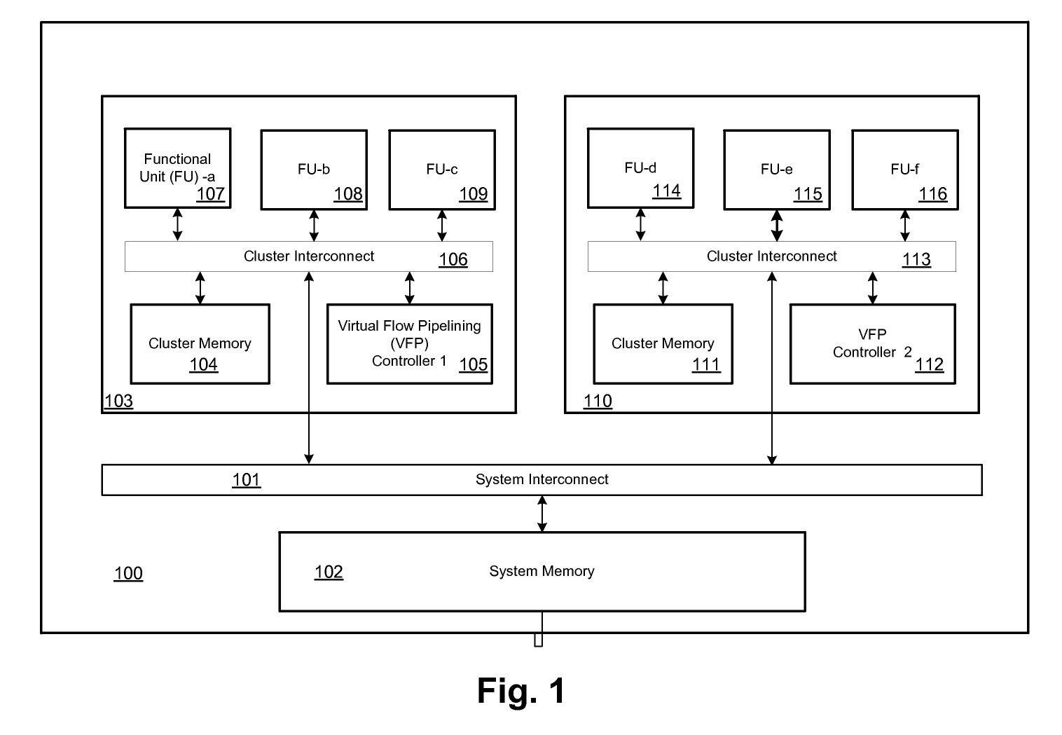

FIG. 1 shows the System-on-a-Chip (SoC) organization with multiple clusters (blocks 103 and 110) of functional units (blocks 107, 108, 109, 114, 115, 116), and each cluster operation controlled by a single Virtual Flow Pipeline Controller (blocks 105 and 112). A SoC consists of one or more clusters, and each cluster contains one or more Functional Units (FU-s). The SoC has at least one block of memory (blocks 102, 104, and 111) for data, programs and control information that, and each FU and each cluster can have its own local memory. The hierarchical memory organization and data mapping to local and shared memory block is performed in order to optimize processing performance, and total memory size. The elements of a cluster (FU-s, VFP controller, memory) are connected by Cluster Interconnect (blocks 106 and 113), implemented for instance as a bus, full or partial crossbar. The clusters (blocks 103 and 110) and optional shared system memory (block 102) are connected by System Interconnect (block 101), which can also be implemented as a bus, full or partial crossbar. There can be one or more functional units in the cluster, and one or more clusters in the system, which means that Virtual Flow pipelining control can be fully centralized (one cluster in a system, with multiple FU-s in a cluster), fully distributed (one FU per cluster, with multiple clusters in a system), or hierarchical (multiple clusters, and multiple FU-s per cluster).

The processing is performed as set of tasks, each task performing one function on FU. The sequence of tasks in a set constitutes Virtual Flow. The task is described by its function name, operands, and results. The results consist of: a) output data to be processed by the following tasks, b) status flag used to determine the selection of following tasks among the ones in the per-flow pre programmed set of follow up tasks, and c) status data, called flow context, to be used by the subsequent invocation of the same task in the same flow in order initialize its FU operation.

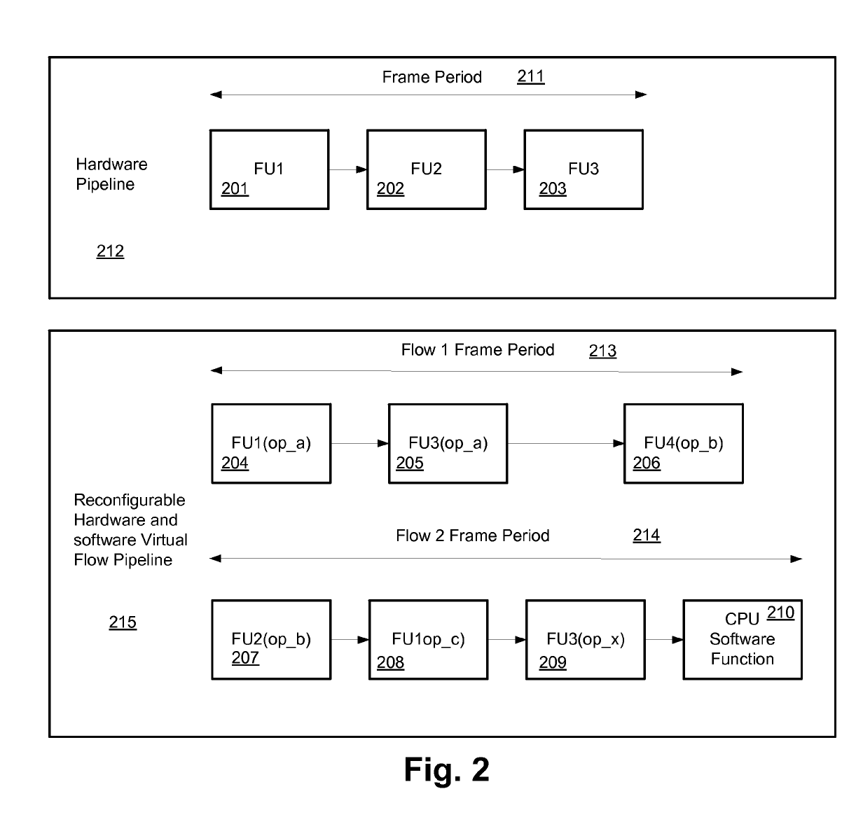

There could exist multiple virtual flows in the system at the same time, as shown on FIG. 2. FIG. 2 shows the difference between hardware based pipeline with fixed sequence of operations (blocks 201 202, 203), and a set of virtual flows in a VFP based system (blocks 204, 205, and 206 in flow 1, and blocks 207, 208, 209, and 210 in flow 2). VFP system, in contrast to hardware based pipeline, supports a) concurrency of flows, b) coexistence of flows with controlled sharing of resources as per scheduling discipline specified for each task in the flow, c) flexibility of ordering of tasks in the sequence, and d) flexibility in a selection of operation for each functional unit performing the task.

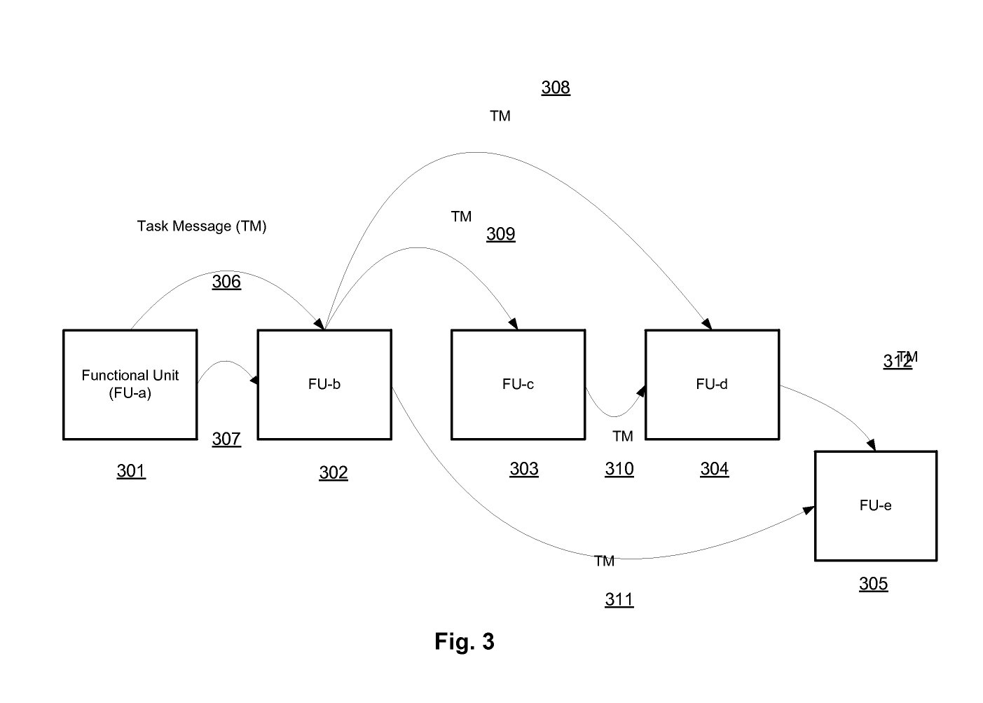

FIG. 3 shows the sequencing of tasks in processing virtual flow. The processing is performed by a number of Functional Units (301, 302, 303, 304, and 305) operating and generating the events consisting of signals and data (306, 307, 308, 309, 310, 311, and 312). The run time control, performed by VFP controller (blocks 105, and 112 on FIG. 1) has to respond rapidly to the event by detecting and decoding it and activating the processing function in charge of handling it. The sequencing of tasks within the constraints of their causal relationships within the virtual flow and service discipline per virtual flow are performed by the control mechanisms of Virtual Flow Pipeline (VFP) controller. In order to meet the functional requirements there is a need to support two levels of hierarchy of operations. At the higher level, the functions are integrated with the event driven control framework into the application. At the lower level, new functions are defined as software defined entities. In order to use system control mechanisms, the software defined and hardware built in functions are treated uniformly at the application level. This hierarchy simplifies application, as well as function level programming.

The stringent performance requirement of wireless protocols, especially at the baseband layer, needs to be supported at the architecture level with mechanisms that will guarantee processing latency, timely response, and provisioned quality of service parameters. The scheduling mechanisms are implemented by VFP controller in order to satisfy requirements of individual flows as well as to efficiently share the processing resources between the flows

The application programming interface (API) provides access to the architectural features of VFP to the programmer The API will provide access to the event driven control structure for describing the relationship between the events and the processing functions. In addition, in order to allow for a user-friendly control and monitoring of the application performance, API allows expressing the performance requirements in terms of latency, bandwidth, resource reservations, and QoS parameters. Virtual flow consists of a set of functions and their scheduling requirements associated with a higher protocol entity (application, session, IP, or MAC address). In a VFP scheme, the sequence of operations is organized by a flow control data structure which specifies, for each function completed, the follow up candidate functions. The actual sequence of functions is selected at run time, result of each task. Hence, the potential sequence space is defined during the flow provisioning time, but the actual operation sequence is determined at run time. The sequencing of operations is controlled by the built in VFP synchronization mechanisms that ensure that a functional unit does not start the processing until all of the previous units in the flow have completed processing.

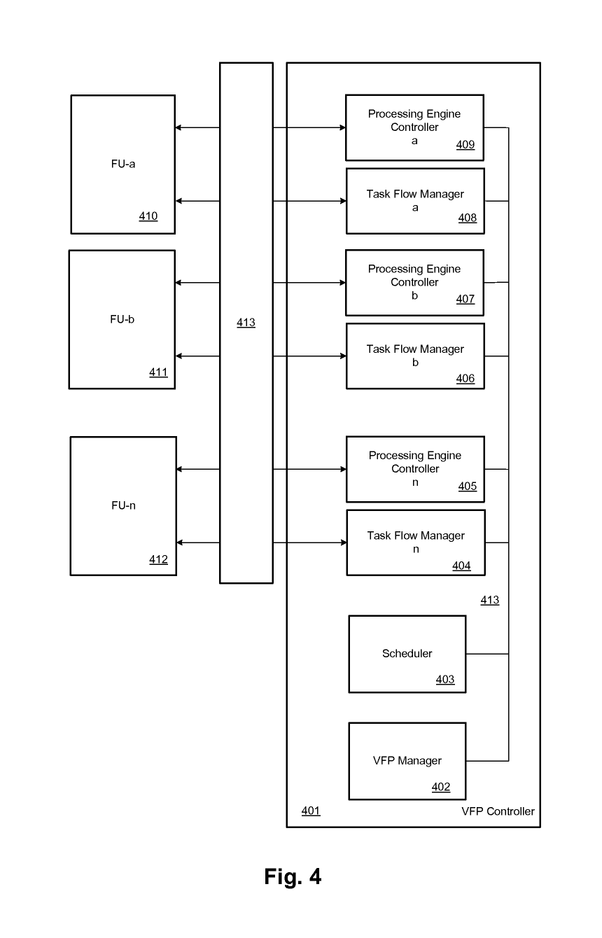

The timing of the operations is also provisioned per flow, but dynamically selected based on the run time results. The scheduling function of the VFP controller multiplexes each functional unit (hardware or programmable processor) either based on a time reservation or a statistical multiplexing scheme, depending on the flow setup. In order to support synchronous framing type of protocols (e.g., time division multiplexing), the flow scheduling information for the time reservation based scheme also specifies the repetition time. The scheduler (block 403 on FIG. 4) is in charge of ensuring both the deterministic and the statistical (average type) performance guaranties.

The VFP programming is based on a set of control data structures for controlling its operation: Global Task Table, Scheduler Queues, and Task Flow Graph.

Global Task Table This table is created by the system management utility and parsed by VFP controller in order to decode functional unit in charge of task execution, and synchronize task execution with the completion of all producer tasks. Global Task Table is array indexed by TaskID—task identifier.

Task Scheduler Queues consists of one synchronous task queue and multiple asynchronous task queues per functional unit (FU). The queues are formed by linking the Queue Descriptors in the linked list structures. The Synchronous queue is organized and processed earliest time slot first, while each asynchronous queue is organized and served in a FIFO manner based on task triggering time, and asynchronous queues are served with either fixed, round robin or Withed Round Robin (WRR) serving discipline per FU. The queues are realized as linked lists of Task Scheduler Queue Descriptors. The queues are described with head and tail pointers stored in the control registers of VFP controller unit.

Task Flow Graph is a directed graph structure that controls task execution flow. The task flow is triggered either by asynchronous events or by triggering synchronous task based on the global timer value. The tasks are functions executed by processing engines, or threads of the data processor. The task execution is performed as the sequence of producer-consumer tasks that can be executed with performance guaranties within guarantied time slots, or in a best effort approach. The producer task is the task proceeding to the particular task, while consumer task(s) is (are) the following ones.

The virtual flow pipeline control mechanism performs task (function insanitation) sequencing, scheduling tasks, function execution control and function synchronization.

FIG. 4 shows one type of architecture organization of Virtual Flow Pipelining Controller. Scheduler (block 403) is processing the scheduler queues and selects the next Task Descriptor to process and updates the queues accordingly. It feeds the selected Task Descriptor to the Processing Engine Controller (blocks 405, 407, and 409). The processing engine controller takes the fields from the processing engines that are required for command processing (command, input and output data pointers and sizes) and feeds them to the Processing Engine of Functional Unit. It monitors command execution, gets notified about command completion and checks which target tasks listed in the Task Descriptor need to be activated. The task Flow Manager (blocks 404, 406, and 408) gets the indication of the tasks to be activated from the Processing Engine Controller and activates them be updating synchronization semaphore and inserting the asynchronous task into the target functional units scheduler queues. There is a set of Processing Engine Controller and Task Flow Manager blocks within VFP controller associated with each Functional Unit. The VFP manager (block 402) controls operation of other blocks in VFP controller (Scheduler, Processing Engine Controllers, and Task Flow Managers).

The VFP based system supports processing multiple wireless and wired communication protocol simultaneously. Multiple flows are processed as the sequence of tasks, controlled by VFP task sequencing method. The operation of each task, and the task sequencing is provisioned as per requirements of the communication protocol, while the system computing, memory and interconnect resources are allocated for each flow as per protocol and communication session performance requirements. The allocation of resources is specified during the session provisioning time, while the actual allocation is carried over by VFP control methods at run time. Furthermore, the protocol processing can be changed at run time by the VPF control methods which selectively sequence the consumer tasks based on the results of producer tasks.

The VFP based system can implant OFDM (Orthogonal Frequency Division Multiplexing) baseband protocol. In one example, the system was built as FPGA design using two X5-400M Innovative Integration boards, each using one FPGA Xilinx Virtex5 SX95T component. FPGA technology was used as the implementation fabric but the programmability of this version comes from Virtual Flow Pipelining (VFP) architecture and corresponding Application Programming Interface (API-s). The system consisted of fully distributed VFP control (one VFP controller per cluster, one FU per cluster) hardware processing units each one capable of performing set of functions at the particular domain: MAC, modulator, demodulator, FFT/IFFT, frame-checker, etc. The CPU was used in the control and management role: to set up processing flow, control and monitor demo, and interface to application programs. One Innovation Integration's X5-400M board is used for the transmitter and the other one for the receiver implementation. The split across the receiver and transmitter sections was the most natural way of dividing logic but not the necessary one. Two boards were used because of the capacity limitation. The X5-400M is PCI Express Mezzanine Card (XMC) IO module having the following features: Two 14-bit, 400 MSPS A/D and two 16-bit, 500 MSPS DAC channels, Virtex5 FPGA-SX95T, PCI Express host interface with 8 lanes, 1 GB DDR2 DRAM, 4 MB QDR-II. The Register Transfer level design, based on System Verilog language, was built in order to support hierarchical VFP control (multiple clusters and multiple FU-s per cluster). The Register Transfer level design also supports software programmable Functional Units using Tensilica LX-2 data plane configurable processor with custom designed instructions for flexible MIMO (Multiple Input Multiple Output Antenna) detection processing and flexible OFDM interleaver, de-interleaver processing.

What is claimed is:

1. A computer system for embodying a virtual flow pipeline programmable processing architecture for a plurality of wireless protocol applications, comprising:
a plurality of functional units for executing a plurality of tasks;
a synchronous task queue and a plurality of asynchronous task queues for linking the plurality of tasks to be executed by the functional units in a priority order;
a virtual flow pipeline controller including:
a processing engine for processing a plurality of commands;
a scheduler, communicatively coupled to the processing engine, for selecting a next task for processing for each of the plurality of functional units at run time;
a processing engine controller, communicatively coupled to the processing engine, for providing commands and arguments to the processing engine and monitoring command completion; and
a task flow manager, communicatively coupled to the processing engine controller, for activating the next task for processing.

2. The computer system for embodying a virtual flow pipeline programmable processing architecture of claim 1 further comprising a plurality of control data structures for controlling operation of the processing engine controller.

3. The computer system for embodying a virtual flow pipeline programmable processing architecture of claim 2 wherein the plurality of control data structures further comprises a global task table for providing a common memory component shared by the plurality of functional units in the system.

4. The computer system for embodying a virtual flow pipeline programmable processing architecture of claim 3 wherein the global task table determines the functional unit responsible for task execution, inserts asynchronous tasks into the functional unit's queues, and synchronizes task execution with a completion of all producer tasks, wherein the producer tasks represent the tasks preceding the next task to be executed.

5. The computer system for embodying a virtual flow pipeline programmable processing architecture of claim 2 wherein the plurality of control data structures further comprises a task scheduler queue.

6. The computer system for embodying a virtual flow pipeline programmable processing architecture of claim 2 wherein the plurality of control data structures further comprises a directed graph structure that controls task execution flow.

7. The computer system for embodying a virtual flow pipeline programmable processing architecture of claim 1 wherein the processing engine controller and scheduler link together a sequence of tasks for performing the functions of the wireless protocol application to form a virtual channel pipeline.

8. The computer system for embodying a virtual flow pipeline programmable processing architecture of claim 7 wherein the virtual channel pipeline is characterized by the sequence of tasks to be performed, a duration for each individual task, and a repetition time period for a plurality of synchronous tasks.

9. The computer system for embodying a virtual flow pipeline programmable processing architecture of claim 7 wherein the computer system supports a plurality of virtual channels simultaneously.

10. The computer system for embodying a virtual flow pipeline programmable processing architecture of claim 9 wherein each of the plurality of virtual channels is associated with one of the plurality of wireless protocol applications.

11. The computer system for embodying a virtual flow pipeline programmable processing architecture of claim 1 wherein the processing engine controller retrieves a command that corresponds to the next task to be executed, inputs data to a local memory of the functional unit assigned to execute the task, and assigns the command to a processing component of the functional unit assigned to the task.

12. The computer system for embodying a virtual flow pipeline programmable processing architecture of claim 8 wherein the processing engine controller moves a result from the local memory to an output data buffer following command execution.

13. The computer system for embodying a virtual flow pipeline programmable processing architecture of claim 7 wherein the virtual channel pipeline is characterized by the sequence of tasks to be performed, a duration for each individual task, and a repetition time period for a plurality of synchronous tasks.

14. The computer system for embodying a virtual flow pipeline programmable processing architecture of claim 7 wherein the tasks in a virtual channel pipeline are assigned to a plurality of functional units.

15. The computer system for embodying a virtual flow pipeline programmable processing architecture of claim 7 wherein the computer system supports a plurality of virtual channels simultaneously.

16. The computer system for embodying a virtual flow pipeline programmable processing architecture of claim 1 wherein the plurality of synchronous tasks have guaranteed execution time slots.

17. The computer system for embodying a virtual flow pipeline programmable processing architecture of claim 1 wherein the guaranteed execution time slots are provided by a global timer.

18. The computer system for embodying a virtual flow pipeline programmable processing architecture of claim 17 further comprising assigning and allocating the time slots based on a framing requirement for a set of synchronous tasks wherein the framing requirement including a time length of the task sequence and a repetition period.

19. The computer system for embodying a virtual flow pipeline programmable processing architecture of claim 1 wherein the asynchronous tasks are executed by functional units based on a fixed priority arbitration of the plurality of asynchronous task queues wherein each asynchronous queue is served in a first-in, first-out order.

20. The computer system for embodying a virtual flow pipeline programmable processing architecture of claim 1 wherein the asynchronous tasks are executed by functional units based on a weighted round robin arbitration of the plurality of asynchronous task queues

21. The computer system for embodying a virtual flow pipeline programmable processing architecture of claim 1 wherein the next task selected for each functional unit is based on a provisioned task flow or a run time allocation using a dynamic load balancing wherein tasks are assigned to functional units based on the functional unit load.

22. The computer system for embodying a virtual flow pipeline programmable processing architecture of claim 1 wherein the synchronous and asynchronous queues are organized as a linked list of task scheduler queue descriptors.

23. A computer-implemented method for executing a plurality of wireless protocol applications embodying a virtual flow pipeline programmable processing architecture in a computer system, the method comprising:
placing a plurality of tasks to be executed by a plurality of functional units in the computer system into a plurality of task queues including a synchronous task queue and a plurality of asynchronous task queues;
linking the plurality of tasks to be executed by the functional units in a priority order;
processing a plurality of commands by a processing engine component of a virtual flow pipeline controller;
selecting a next task for processing for each of the plurality of functional units at run time by a task flow manager coupled to the processing engine component;
providing commands and arguments to the processing engine and monitoring command completion by a processing engine controller; and
activating the next task for processing by a task flow manager coupled to the processing engine controller.

24. The computer-implemented method for executing a plurality of wireless protocol applications of claim 23 further comprising provisioning a plurality of flows and multiplexing the plurality of provisioned flows among the plurality of functional units.

25. The computer-implemented method for executing a plurality of wireless protocol applications of claim 23 further comprising multiplexing each functional unit based on a time reservation or a best effort scheme depending on flow setup.

26. The computer-implemented method for executing a plurality of wireless protocol applications of claim 23 further comprising controlling operation of the processing engine controller by a plurality of data structures including a global task table, a task scheduler queue, and a directed graph structure for controlling task execution flow.

27. The computer-implemented method for executing a plurality of wireless protocol applications of claim 26 wherein the global task table provides a common memory component shared by the plurality of functional units in the computer system.

28. The computer-implemented method for executing a plurality of wireless protocol applications of claim 27 further comprising determining at run time the functional unit responsible for task execution, inserting asynchronous tasks into the functional unit's queues, and synchronizing task execution with a completion of all producer tasks, wherein the producer tasks represent the tasks preceding the next task to be executed.

29. The computer-implemented method for executing a plurality of wireless protocol applications of claim 27 further comprising determining at run time functions to be performed next based on the results of the producer task, where the functions are selected based on the candidate functions as specified in the task flow graph control data structure.

30. The computer-implemented method for executing a plurality of wireless protocol applications of claim 27 further comprising sequencing the plurality of tasks for performing the functions of the wireless protocol application to form a virtual channel pipeline.

31. The computer-implemented method for executing a plurality of wireless protocol applications of claim 30 wherein the plurality of tasks are sequenced based on a duration for each individual task, and a repetition period for the plurality of synchronous tasks.

32. The computer-implemented method for executing a plurality of wireless protocol applications of claim 30 further comprising providing simultaneous support for a plurality of multiplexed virtual channels.

33. The computer-implemented method for executing a plurality of wireless protocol applications of claim 32 further comprising associating each of the plurality of multiplexed virtual channels with one of the plurality of wireless applications.

34. The computer-implemented method for executing a plurality of wireless protocol applications of claim 23 further comprising retrieving a command corresponding to the next task to be executed, inputting data to a local memory of the functional unit responsible for the task, assigning the command to a processing component of the functional unit assigned to the task, and moving a result form the local memory to an output data buffer following command execution.

35. The computer-implemented method for executing a plurality of wireless protocol applications of claim 23 further comprising assigning the tasks in a virtual channel pipeline to a plurality of functional units.

36. The computer-implemented method for executing a plurality of wireless protocol applications of claim 23 further comprising providing a guaranteed execution time slots to each of the plurality of synchronous tasks using a global timer.

37. The computer-implemented method for executing a plurality of wireless protocol applications of claim 36 further comprising assigning and allocating time slots based on a framing requirement for a set of synchronous task wherein the framing requirement includes a time length of the task sequence and a repetition period.

38. The computer-implemented method for executing a plurality of wireless protocol applications of claim 23 wherein the asynchronous tasks are executed by functional units based on a fixed priority arbitration of the plurality of asynchronous task queues wherein each asynchronous queue is served in a first-in, first-out order.

39. The computer-implemented method for executing a plurality of wireless protocol applications of claim 23 wherein the asynchronous tasks are executed by functional units based on a weighted round robin arbitration of the plurality of asynchronous task queues.

40. The computer-implemented method for executing a plurality of wireless protocol applications of claim 23 further comprising assigning tasks to functional units via a run time allocation using a dynamic load balancing based on the functional unit load.

41. The computer-implemented method for executing a plurality of wireless protocol applications of claim 23 further comprising organizing the synchronous and asynchronous queues as a linked list of task scheduler descriptors.
